(19) United States
(12) Patent Application Publication
(10) Pub. No.: US 2026/0334484 A1
(43) Pub. Date: Oct. 29, 2026

(54) APPARATUS FOR DETACHING MEAT FROM A CARCASS OR PARTS THEREOF, AND APPARATUS AND METHOD FOR AUTOMATICALLY PROCESSING PRODUCTS OF THE FOOD-PROCESSING INDUSTRY

(71) Applicant: Nordischer Maschinenbau Rud. Baader GmbH + Co. KG, Lübeck (DE)

(72) Inventor: Werner TYCHSEN, Lübeck (DE)

(73) Assignee: Nordischer Maschinenbau Rud. Baader GmbH + Co. KG, Lübeck (DE)

(21) Appl. No.: 19/116,145

(22) PCT Filed: Sep. 19, 2023
(86) PCT No.: PCT/EP2023/075750

§ 371 Date: Mar. 27, 2025

(30) Foreign Application Priority Data
Sep. 30, 2022 (EP) 22199054.2

(51) Int. Cl. A22C 25/16; A22C 25/08

(52) U.S. Cl. CPC A22C 25/16; A22C 25/08

(57) ABSTRACT

An apparatus for detaching meat from a carcass or parts thereof, includes at least one cutting unit, which has at least one knife carrier with a knife shaft rotatably mounted in the knife carrier, a circular knife being arranged and fixed on the knife shaft in a form-fitting manner and in a rotationally fixed manner with respect to the knife shaft, and a drive for rotationally driving the knife shaft, the circular knife is held and fixed on the knife shaft between an abutment of the knife shaft and a securing means, which is arranged on the side of the free end of the knife shaft, at least one compensating element being optionally arranged between the circular knife and the abutment and/or between the circular knife and the securing means.

### CROSS-REFERENCE TO RELATED APPLICATIONS

The present application is the National Phase entry of International Patent Application No. PCT/EP 2023/075750 filed Sep. 19, 2023, which claims priority to European Patent Application No. 22199054.2 filed Sep. 30, 2022, the entire contents of both are hereby incorporated by reference into this application.

### TECHNICAL FIELD

The present disclosure relates to an apparatus, configured and adapted for detaching meat from a carcass or parts thereof, comprising at least one cutting unit, which has at least one knife carrier with a knife shaft rotatably mounted in the knife carrier, a circular knife being arranged and fixed on the knife shaft in a form-fitting manner and in a rotationally fixed manner with respect to the knife shaft, and a drive for rotationally driving the knife shaft.

The present disclosure further relates to an apparatus for automatically processing products of the food processing industry, in particular for processing slaughtered, gutted fish opened at the abdominal cavity, comprising a transport unit, configured and adapted for transporting the products to be processed in transport direction T along a transport path through at least one processing station, at least one processing station for processing the products, namely an apparatus for detaching meat from a carcass or parts thereof, and a control device for controlling the transport unit and the or each processing station.

The present disclosure also relates to a method for automatically processing products of the food processing industry, in particular for processing slaughtered, gutted fish opened at the abdominal cavity.

### BACKGROUND

Such apparatuses and methods are used particularly in the food processing industry and particularly in the processing of fish. The known apparatuses for detaching meat from the carcass are used, for example, to detach the meat, which is later obtained as a fish fillet, from the carcass. By way of example, reference is made to cutting free the ventral bones and the backbones, in which two circular knives are positioned on either side of the ventral bones or backbones, respectively. The meat along the bones is detached therefrom by the apparatus for detaching the meat from the carcass. For optimum yield, it is necessary to cut as close as possible along the bones so that as little meat as possible remains on the bones. However, the generic apparatuses and the method are also used in other areas of the food processing industry, in particular fish processing, namely, for example, for the flank cut or the trunk cut in the context of processing fish. The apparatus for detaching the meat from the carcass can be operated as an individual processing station but may be a component part of the apparatus for automatically processing the products.

The apparatus for detaching the meat from the carcass or parts thereof describes not only partial separation, i.e. a kind of loosening of the meat from the bones, but can also mean complete separation of the meat from the carcass. The wording “detaching meat from the carcass” generally describes any type of meat, i.e. including pork, beef, but in particular poultry and fish, the carcass in some animal species describing the skeleton or individual bones of the skeleton and only in fish being referred to as the carcass.

Different options for adjusting the respective cutting or separating knives are used to be able to move the circular knives into a good cutting position, i.e. as close to the bones as possible. Known apparatuses, for example, have drives, in particular servomotors or stepper motors, by which an adjustment can be carried out. Other known embodiments of such apparatuses include, for example, pneumatic components for adjustment. It is additionally known to resiliently mount the separating/cutting knives themselves and/or the knife holders carrying the separating/cutting knives. These known apparatuses, however, all have the common disadvantage that the technical implementation is complex and therefore cost-intensive. With all the known adjustment mechanisms, considerable masses have to be moved, which are large in relation to the mass of the separating/cutting knives. Furthermore, the known apparatuses or their separating/cutting knives are usually limited to an axial adjustment. In other words, the known solutions only enable the separating/cutting knives to be adjusted in an axis of movement transverse to the transport direction towards the products to be processed and back again. All disadvantages result in an ineffective recovery of meat from the carcass which is limited with regard to the yield.

The object of the present present disclosure is therefore to create a simple and efficient apparatus for detaching meat and for automatically processing products of the food processing industry. Furthermore, the object of the present disclosure is to propose a corresponding method.

### SUMMARY

This object is achieved by an apparatus for detaching meat from a carcass with the features referred to at the outset in that the circular knife is held and fixed on the knife shaft between an abutment of the knife shaft and a securing means, which is arranged on the side of the free end of the knife shaft, at least one compensating element optionally being arranged between the circular knife and the abutment and/or between the circular knife and the securing means. The form-fit connection between the circular knife and the knife shaft can be created, for example, with at least one key and slot joint. Other connections with which the circular knife is driven by the rotation of the knife shaft can also be used. The or each compensating element enables small compensating movements of the circular knife on the knife shaft, in particular tilting of the circular knife, e.g. initiated by the fish itself. A controllable circular knife is created by the or each compensating element. If the circular knife is displaced by an external force, which can also come from the fish itself as the circular knife slides on the bones of the fish, i.e. if it is pushed apart or pushed away from the fish, the compensating element yields so that the circular knife can move within a narrow range, for example in the range between 1-3 mm. Ultimately, no mass actually has to be moved in this case, it only has to be tilted about a tilt axis. This creates a very dynamic system with a flexible circular knife, which enables a precise and efficient yield. The solution according to the present disclosure has a very simple design, which means that existing systems in particular can also be retrofitted easily.

Expediently, the apparatus comprises two cutting units, which are configured identical in construction and are arranged spaced apart from each other substantially mirror-symmetrically on either side of a transport path for the products to be processed, in such a manner that a transport path for the products to be processed is formed between the two circular knives. The two circular knives of the two cutting units engage in the product to be processed from opposite sides at the same time or with a time delay, for example on either side of ventral bones or backbones. The two cutting units can have a common, continuous knife shaft, but, in some embodiments, comprise separate knife shafts. A common drive can be provided for the cutting units. In some embodiments, each cutting unit comprises a separate drive, it being possible to control the drives asynchronously or synchronously by a control device.

In a development of the apparatus according to the present disclosure, the or each compensating element is a flexible sealing element, in some embodiments a flexible O-ring. However, embodiments other than a simple rubber ring can also be used, for example a sleeve made from flexible material. Each compensating element can be configured resiliently and/or elastically. Optionally, a plurality of compensating elements, for example in the form of spring assemblies or the like, can also be arranged on each side of the circular knife. This embodiment ensures a simple construction, which provides sufficient compensating movement.

In some embodiments, the abutment for the circular knife is formed by a shoulder in the knife shaft. This makes it particularly easy to thread the “compensating element”, “circular knife”, “compensating element” components onto the knife shaft. However, the abutment can also be formed in a different manner, e.g. by abutment rings or the like which are formed separately from the knife shaft.

In some embodiments of the apparatus according to the present disclosure, the circular knife and the or each compensating element is held pressed against the abutment by the securing means. The circular knife and the or each compensating element are sandwiched between the securing means and the abutment. An arrangement of the securing means on the free end of the knife shaft ensures simple and reliable fixing of the circular knife and the or each compensating element on the knife shaft.

In some embodiments of the apparatus according to the present disclosure, at least one sliding body is provided, which is arranged spaced apart radially from the knife shaft and can be pressed against the circular knife. The or each sliding body can serve as a kind of passive fixed abutment for the circular knife, for example to protect the circular knife from overloading in the plastic range, or to suppress wobbling of the circular knife, but can also be configured and adapted as a control means for actively adjusting the circular knife for an optimised cutting position. The sliding body can be a simple sliding block. Optionally, each sliding body can also be a sliding plate or the like in the form of a circular segment. Each sliding body is configured and adapted such that hydrodynamic sliding between the sliding body and the circular knife is ensured.

In some embodiments, the or each sliding body is positioned on the inner side of the circular knife directed towards the product to be processed. This particularly supports desired sliding of the circular knife along or on the bones. With the arrangement of a single sliding body, only a low load is exerted on the circular knife, as a result of which the circular knife retains a high degree of flexibility and has only a low level of tension and therefore a longer service life. With the arrangement of the or each sliding body on the inner side directed towards the product to be processed, it is possible to react particularly well to processing of fish, of which the bone thickness is unknown. In other cases, the or each sliding body can also be placed on the outer side of the circular knife to control the or each circular knife to “insert” the fish or the respective bone. As soon as the fish is then cut into, the circular knife is released by the or each sliding body by bringing the or each sliding body out of contact with the circular knife. Ultimately, however, a combination of active and passive sliding bodies can also be used on the inner side and/or outer side of the circular knives.

For this purpose, the or each sliding body is arranged outside the engagement region of the circular knife in the product to be processed, in some embodiments, below or above the axis of rotation of the knife shaft, to bear against the inner side of the circular knife directed towards the product to be processed. The position of the or each sliding body above or below depends on what exactly is to be cut. When cutting backbones, sliding bodies are located above the knife shaft. When cutting ventral bones, sliding bodies are located below the knife shaft. This makes it easy to push the region of the circular knife which can be brought into engagement with the product to be processed closer to the bones of the product to be processed. The position of the or each sliding body outside the engagement region enables multiple actuation, so that the circular knife can be individually adapted to the respective shape of the product to be processed.

The sliding body can have a passive effect. In some embodiments, however, the or each sliding body can be actively controlled. For this purpose, control means, such as a spindle, a pneumatic cylinder or the like, which are connected to a control device, are provided. Depending on the positioning of the or each sliding body, the circular knife can be adjusted axially or about other axes of movement.

In some embodiments of the apparatus according to the present disclosure, at least two sliding bodies are provided, which can be controlled independently of each other. This enables synchronous or asynchronous control/adjustment of each sliding body. With two or more sliding blocks, smaller movements of the circular knife are possible in several axes of movement or in different tilt planes. In particular, the interaction of two or more sliding bodies, i.e. the individual actuation of the two or more sliding bodies, enables variable adjustment of the cutting point of the circular knives. The region of the shortest distance between two mutually opposing circular knives can be adjusted by tilting the circular knives by the sliding bodies in and counter to the direction of transport of the products to be processed, so that the circular knives can be individually controlled open, i.e. the distance between them can be increased, or they can be individually controlled closed, i.e. the distance between them can be decreased. The number of sliding bodies can also be used to influence the flexibility of the circular knives. The more sliding bodies are provided, the lower the flexibility.

In some embodiments, the or each sliding body has at least one through-hole to which a connection element for coolant can be connected. One or more holes can be provided to supply the sliding body with a coolant. Cooling lines, e.g. water lines, may be connected to the or each hole, opening or aperture in order to reduce the friction between the sliding body and the circular knife by the coolant and to dissipate heat generated by friction.

Each sliding body can be stationary with regard to its positioning-with the exception of adjustability towards and away from the circular knife due to the active control. This means that the control/adjustment movement of the sliding body always acts at the same position of the circular knife. In some embodiments, the or each sliding body is configured and adapted to be movable, in such a manner that the contact position of the or each sliding body on the circular knife is variably adjustable. The fact that the position at which the sliding body meets the circular knife is variable increases the individual adjustment options, which results in improved yield efficiency.

As already mentioned, the circular knife has an aperture or a recess to position and fix the circular knife on the knife shaft in a form-fitting manner. In some embodiments, the or each circular knife has at least one further aperture in addition to the recess for producing the form-fit with the knife shaft. In other words, the circular knife is reduced in material and weight by the or each additional aperture. This results in increased flexibility of the circular knife, which simplifies and improves adaptation of the circular knife to individual cutting contours and, in particular, sliding of the circular knife on the bones for improved yield efficiency.

In some embodiments, each circular knife has a plurality of additional apertures, which are configured as involutes or similar to an involute. This further supports the aspects previously described. With each additional aperture, the circular knife becomes more pliant or more flexible, so that the circular knife itself forms a spring element, so to speak, by which a controlled knife is created or supported.

In some embodiments, one cutting edge of each circular knife has two chamfers, the chamfer directed towards the meat to be detached being longer than the chamfer directed away from the meat. The number and configuration of the chamfers can vary. Due to a configuration in which the chamfer directed towards the bone from which the meat is to be detached is smaller than the chamfer directed towards the meat to be detached, it is possible, even without active adjustment or control, for the circular knife in combination with the or each compensating element to move itself towards the bone as soon as the circular knife is engaged in order to then slide along the bone.

In some embodiments, the apparatus comprises a control device. Individual components or all components of the apparatus can be connected to the control device, for example the drives for the circular knives, the control means for the or each sliding body and other components for automated processing.

The object is also achieved by an apparatus for automatically processing referred to at the outset in which the apparatus for detaching is configured and adapted according to one or more of the claims. The aspects arising from this have already been described in connection with the apparatus for detaching, which is why reference will be made to the relevant passages to avoid repetitions.

The object is also achieved by a method referred to at the outset which includes the steps: Transporting the products to be processed along a transport path into the region of at least one processing station and through this by a transport unit, processing the products in the processing station by detaching meat from the carcass by an apparatus for detaching meat from a carcass or parts thereof, the method steps for automatic execution being controlled by a control device, and a circular knife of the apparatus for detaching the meat being passively controlled by the product to be processed, independently of the control device, during execution of the detaching step with respect to its position relative to the carcass by mounting the circular knife on the knife shaft, which permits a compensating movement of the circular knife on the knife shaft. Since the passive control of the circular knife takes place by mounting the circular knife on the knife shaft, it is possible to dispense with elaborate and complex designs for a passive control system. Due to the passive control of the circular knife with the aid of mounting the circular knife on the knife shaft, only very low masses need to be moved or merely tilted, which simply and reliably ensures individual adjustment of the circular knife to the product to be processed for maximum yield.

In some embodiments, the circular knife, in addition to being passively controlled by at least one sliding body, is actively controlled when the meat is detached from the carcass, in that the or each sliding body is actively pressed against the circular knife with adjustable pressure from an inner side of the circular knife directed towards the product to be processed. As a result, the circular knife can be pressed even more tightly against and closer to the bones to be cut free. The or each sliding body is in contact with the circular knife, namely in the region of a plane spanned by the circular knife, or is brought into contact therewith. The pressure can be individually varied using actuators in order to adjust the magnitude of the deflection/the amount of tilting of the circular knife on the knife shaft.

In some embodiments, two or more sliding bodies are actuated separately from one another in order to be brought into contact with the circular knife in different positions thereof. This ensures that the circular knife can be adjusted about several axes of movement, thus ensuring even more individual and yield-optimised adjustment of the circular knife.

Expediently, the contact surface between the or each sliding body and the circular knife is cooled at least during processing, which ensures reliable processing with a long service life of the circular knives.

In some embodiments, the position of each sliding body is changed before and/or during processing to alter the position of the contact surface between the sliding body and the circular knife radially to an axis of rotation of the knife shaft and/or about the axis of rotation of the knife shaft. By varying the contact position of the sliding bodies with respect to the circular knife, the sliding bodies can engage on different regions of the circular knife outside the engagement region and thus create any number of axes of movement so that the circular knife can be adjusted individually and precisely.

In some embodiments, the method is carried out with an apparatus for detaching meat from a carcass or parts thereof according to the claims or with an apparatus for automatically processing products of the food processing industry, in particular for processing slaughtered, gutted fish opened at the abdominal cavity.

Further aspects arising from the individual method steps have already been described in connection with the apparatus, which is why reference will be made to the relevant passages to avoid repetitions.

### BRIEF DESCRIPTION OF THE DRAWINGS

Further expedient and/or advantageous features and developments of the apparatus and the corresponding method emerge from the dependent claims and the description. Particularly embodiments are explained in greater detail with reference to the attached drawing. The drawing shows:

FIG. 1 a schematic lateral view of a first embodiment of an apparatus for detaching meat from a carcass or parts thereof,

FIG. 2 a schematic lateral view of a further embodiment of the apparatus for detaching meat from a carcass or parts thereof,

FIG. 3 the circular knife of the cutting unit according to FIGS. 1 and 2,

FIG. 4 an alternative embodiment of the circular knife, and

FIG. 5 a schematic view of a first embodiment of an apparatus for automatically processing products of the food processing industry, namely an apparatus for cutting free backbones.

### DETAILED DESCRIPTION

The apparatus shown and according to the present disclosure is used to detach the meat from backbones of a slaughtered, gutted fish opened at the abdominal cavity. The apparatuses according to the present disclosure can also be used in a corresponding manner for detaching and separating meat from other bones, in particular from ventral bones, flank bones and the like, as well as for detaching and separating meat from the bones of other animal products. Of course, the apparatus according to the present disclosure is also configured and adapted in a corresponding manner to detach meat from fish bones before opening of the abdominal cavity and/or before gutting. In other words, the apparatus according to the present disclosure can not only be used in connection with a saddle machine as shown but also, for example, for a ventral cut from below, a trunk cut, separating cuts and various other cuts.

The apparatus 10 shown in the drawing is configured and adapted for detaching meat from a carcass 11 or parts thereof, specifically for cutting free backbones 37 or detaching the meat from the backbones 37 and comprises at least one cutting unit 12, which comprises at least one knife carrier 13 with a knife shaft 14 rotatably mounted in the knife carrier 13, a circular knife 15 being arranged and fixed on the knife shaft 14 in a form-fitting manner and in a rotationally fixed manner with respect to the knife shaft 14, and a drive 16 for rotationally driving the knife shaft 14.

The circular knife 15 is held and fixed on the knife shaft 14 between an abutment 17 of the knife shaft 14 and a securing means 19, which is arranged on the side of the free end 18 of the knife shaft 14, at least one compensating element 20 being optionally arranged between the circular knife 15 and the abutment 17 and/or between the circular knife 15 and the securing means 19.

When taken on their own or in combination with each other, the features and developments described below illustrate embodiments. It is expressly pointed out that features which are summarised in the claims and/or the description and/or the drawing or are described in a common embodiment can also further develop the apparatus 10 described above in a functionally independent manner.

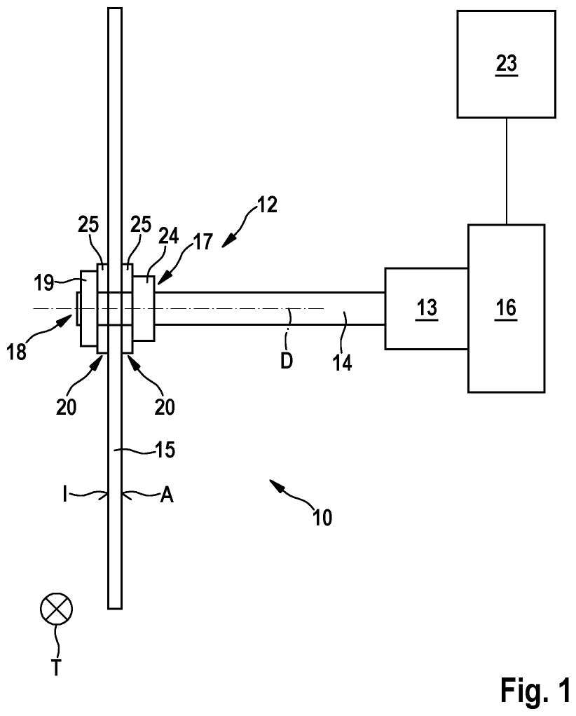

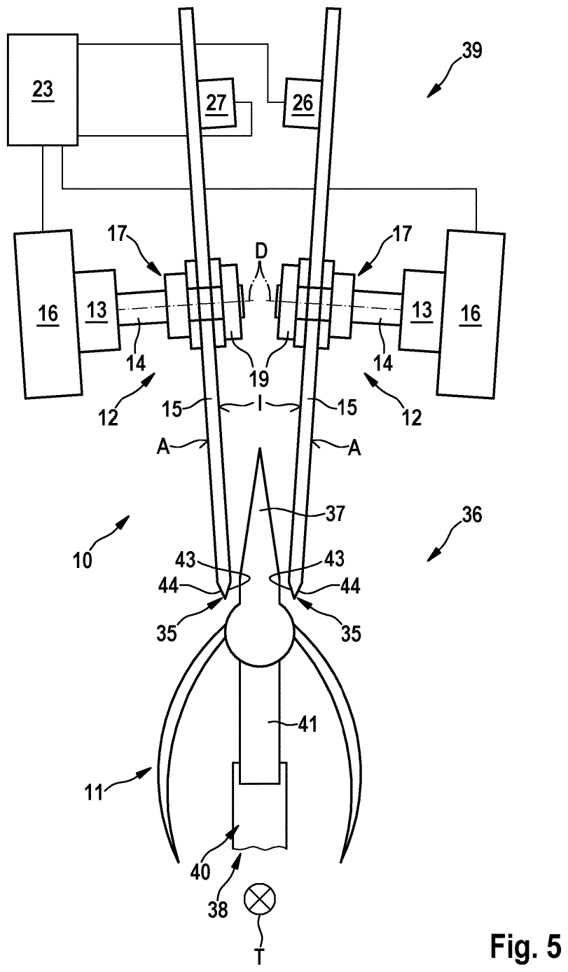

The circular knife 15 has a recess 21 or an aperture which is configured to accommodate the knife shaft 14 and to form a key and slot joint 22 with the knife shaft 14. FIG. 1 shows a single cutting unit 12. The apparatus 10 comprises a control device 23, which is connected to the drive 16 for the knife shaft 14 and thus for the circular knife 15. Optionally (see in particular FIG. 5), the apparatus 10 can also comprise two cutting units 12, which are configured, in some embodiments, identical in construction and are arranged spaced apart from each other substantially mirror-symmetrically on either side of a transport path for the products to be processed, in such a manner that a transport path for the products to be processed is formed between the two circular knives 15. For the sake of simplicity, the same reference numerals are used for the corresponding components of both cutting units 12. The cutting units 12 are optionally each configured and adapted to be adjustable collectively. By actuators (not explicitly shown), which can likewise be connected to the control device 23, the knife carriers 13, for example, can be adjusted to allow the distance and/or the angle of the circular knives 15 to be variably set with respect to the product to be processed.

In an embodiment not explicitly shown, only one compensating element 20 is provided in such a manner that a compensating element 20, then the circular knife 15 and then the securing means 19 are “threaded onto” the knife shaft 14 against the abutment 17. The securing means 19 ensures and is configured, in this and in all other embodiments, to fix the components located between the securing means 19 and the abutment 17 with a defined clamping force or a defined clamping pressure. The components can be arranged directly on the knife shaft 14. In other embodiments, the components can also be arranged on a sleeve or the like, which is axially/linearly movable on the knife shaft 14, the sleeve being configured and adapted movably with respect to the knife shaft 14 against a spring tension or the like.

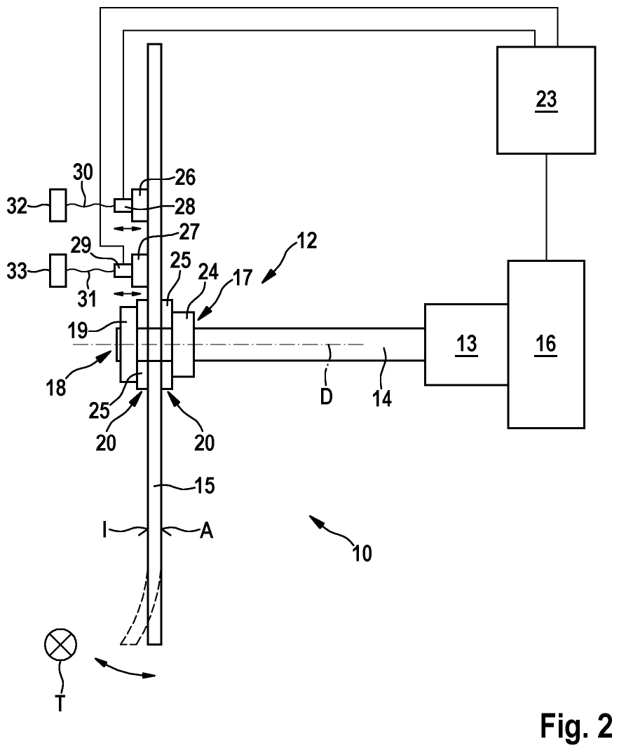

In the embodiment according to FIGS. 1 and 2, the knife shaft 14 is mounted with one end in the knife carrier 13. The free end 18 of the knife shaft 14 protrudes from the knife carrier 13 and points in the direction of the products to be processed. A shoulder 24, which forms the abutment 17 for the circular knife 15, is formed in or on the knife shaft 14. However, the circular knife 15 does not bear directly against the abutment 17 but against a compensating element 20. The compensating element 20 bears against the abutment 17. The circular knife 15 bears against the compensating element 20. This is followed in turn by a compensating element 20 which is located between the circular knife 15 and the free end 18 of the knife shaft 14. The two compensating elements 20 and the circular knife 15 are then held pressed against the abutment 17 by the securing means 19, which can be a simple screw. Both compensating elements 20 are configured as a flexible sealing element 25, as a flexible O-ring in the embodiment shown.

In the embodiment according to FIG. 2, two sliding bodies 26, 27 are provided, which are arranged spaced apart radially from the knife shaft 14 and can be pressed against the circular knife 15. Both sliding bodies 26, 27 are arranged outside the engagement region of the circular knife 15 in the product to be processed and, since the apparatus 10 is configured and adapted for cutting free backbones 37, above the axis of rotation D of the knife shaft 14. The sliding bodies 26, 27 are positioned on the inner side I of the circular knife 15 directed towards the product to be processed. Each sliding body 26, 27 is associated with an actuator 28, 29, by which the sliding body 26, 27 can be moved and, in particular, adjusted towards and away from the circular knife 15 (see in particular the movement arrows in FIG. 2). The actuators 28, 29 are also connected to the control device 23. In the embodiment shown, each of the two sliding bodies 26, 27 can be actively controlled independently of each other. The actuation relates, on the one hand, to the adjusting movement towards and away from the circular knife 15. On the other hand, the actuation relates to a movement for changing the position of the sliding bodies, i.e. for changing the contact position of the or each sliding body 26, 27 on the circular knife 15, by actuators (not explicitly shown) optionally radially to the axis of rotation D of the knife shaft 14 and/or about the axis of rotation D of the knife shaft 14.

An embodiment of the apparatus 10 shown in FIG. 2 has at least one through-hole in each sliding body 26, 27, to which a connection element for coolant can be connected. By way of example, the through-hole is connected to a water reservoir 32, 33 via a line 30, 31. The water can be conveyed into the contact region of sliding body 26, 27 and circular knife 15 by pumps (not explicitly shown) or the like.

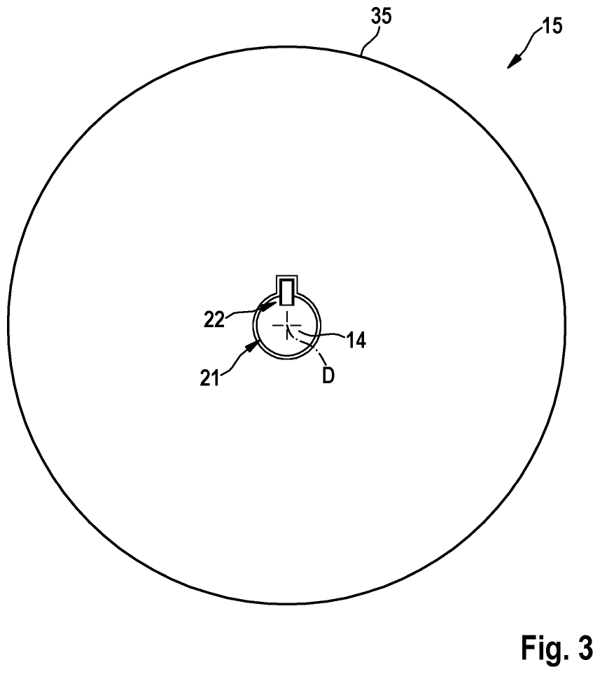

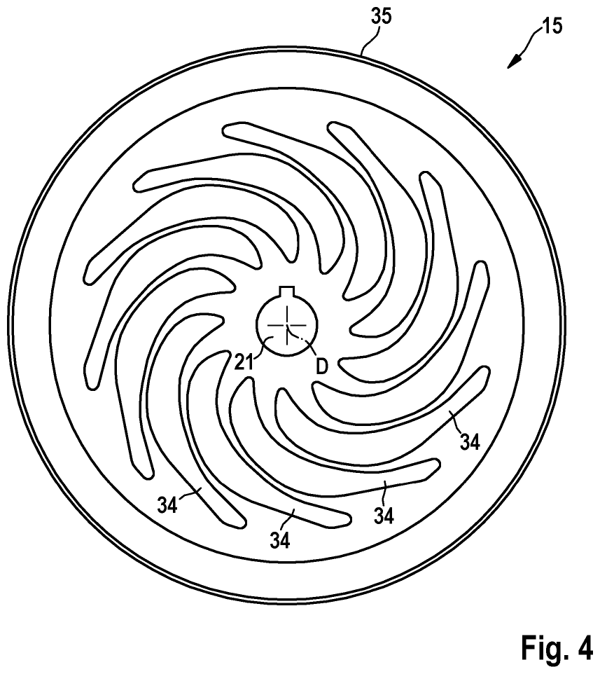

The embodiments according to FIGS. 1 to 3 show a simple circular knife 15 which is closed with the exception of the recess 21 for producing the form-fit with the knife shaft 14. Inner side I and outer side A of the circular knife 15 thus have no connection in the circular knife surface. FIG. 4 shows a circular knife 15 which has at least one further aperture 34 in addition to the recess 21 for producing the form-fit with the knife shaft 14. In some embodiments, each circular knife 15 has a plurality of additional apertures 34, which are configured as involutes or similar to an involute. The apertures 34 are all located at a distance from the cutting edge 35 of the circular knife 15 outside the engagement region of the circular knife 15 in the product to be processed.

FIG. 5 shows a circular knife 15 which has a special cutting edge geometry. The cutting edge 35 of the circular knife 15 comprises two chamfers 43, 44. One of the chamfers 43 is directed towards the backbone 37. The other chamfer 44 is directed towards the meat to be detached. The chamfers 43, 44 can be configured symmetrically. In some embodiments, the chamfer 43 directed towards the backbone 37 is configured to be shorter than the chamfer 44 directed towards the meat.

Expressed differently, the chamfer line of the chamfer 43, starting from the tip of the cutting edge, is shorter than the chamfer line 44, so that the chamfer 44 or the chamfer angle of the chamfer 44 is “more obtuse” than the chamfer 43 or the chamfer angle of the chamfer 43.

The apparatus 10 for detaching meat from a carcass 11 or parts thereof can be used as an independent and separate single unit (see in particular FIGS. 1 and 2) and in particular can be retrofitted to existing apparatuses. In some embodiments, however, the apparatus 10 for detaching meat from a carcass 11 or parts thereof is a component part of an apparatus 36 for automatically processing products of the food processing industry.

The apparatus 10 shown is configured and adapted for processing slaughtered, gutted fish opened at the abdominal cavity. More precisely, the apparatus 36 shown is used for cutting free backbones 37, i.e. for detaching the fish fillets from the carcass 11. The apparatus 36 comprises a transport unit 38 configured and adapted for transporting the products to be processed in transport direction T along a transport path through at least one processing station 39, at least one processing station 39 for processing the products, namely an apparatus 10 for detaching meat from a carcass 11 or parts thereof, and a control device 23 for controlling the transport unit 38 and the or each processing station 39.

The apparatus 36 and the apparatus 10 for detaching is configured and adapted according to one or more of the claims. The apparatus 36 can comprise further processing stations, so that step-by-step processing of the products is ensured along the transport path. In some embodiments, the transport unit 38 comprises a rotationally driven transport chain 40, on which a plurality of transport saddles 41 are arranged for receiving and holding the products to be processed during processing at the different processing stations 39.

The principle of the method is explained in greater detail below based on the drawing. The embodiment is described with reference to the drawing for cutting free backbones of a slaughtered, gutted fish opened at the abdominal cavity. First, the products to be processed, in this case the fish, are transported along a transport path into the region of at least one processing station 39 and through this by a transport unit 38. In the processing station 39, the fish are processed by detaching meat from the carcass 11 by an apparatus 10 for detaching meat from a carcass 11 or parts thereof. By way of example, the fish, which are held on the transport saddle 41, are transported through the apparatus 10 for detaching the meat. To do this, the fish pass through the apparatus 10 for detaching between two circular knives 15, which are positioned on either side of the backbones 37. The meat is detached from the backbones 37 by transporting the fish in transport direction T, on the one hand, and by the rotation of the circular knives 15, on the other hand. The individual method steps are controlled by a control device 23 for automatic execution of the processing. The circular knives 15 of the apparatus 10 for detaching the meat are passively controlled by the product to be processed, independently of the control device 23, during execution of the detaching step with respect to the position relative to the carcass 11 by mounting the circular knife 15 on the knife shaft 14, which permits a compensating movement of the circular knife 15 on the knife shaft 14. First, the circular knives 15 are moved into their cutting position as close to the backbones 37 as possible. During the movement in transport direction T, the circular knives 15 slide along the backbones 37 and are deflected, if necessary, by the backbones 37. This passive control of the circular knives 15 is possible as the circular knives 15 are tiltably mounted on the knife shaft 14.

In some embodiments, the circular knives 15, in addition to being passively controlled by at least one sliding body 26, 27, are actively controlled when the meat is detached from the carcass 11, in that the or each sliding body 26, 27 is actively pressed against the circular knife 15 with adjustable pressure from an inner side I of the circular knife 15 directed towards the product to be processed. By pressing the sliding bodies 26, 27 against the circular knife 15 from the inside above the axis of rotation D of the knife shaft, the circular knives 15 tilt closer to the backbones 37.

Optionally, two or more sliding bodies 26, 27 for each circular knife 15 can be actuated separately from one another in order to be brought into contact with the circular knife 15 in different positions thereof. Particularly during processing, the contact surfaces between the or each sliding body 26, 27 and the circular knife 15 are cooled.

The contact surfaces between the sliding body 26, 27 and the circular knife 15 can be stationary, i.e. always located in the same position. Optionally, the position of each sliding body 26, 27 can be changed before and/or during processing to alter the position of the contact surface between the sliding body 26, 27 and the circular knife 15 radially to an axis of rotation D of the knife shaft 14 and/or about the axis of rotation D of the knife shaft 14.

The method is carried out using an apparatus 10, 36 according to one or more of the claims.

1. An apparatus configured to detach meat from a carcass or parts thereof as a product to be processed, comprising:
at least one cutting unit, which has at least one knife carrier with a knife shaft rotatably mounted in the knife carrier,
a circular knife being arranged and fixed on the knife shaft in a form-fitting manner and in a rotationally fixed manner with respect to the knife shaft, and
a drive for rotationally driving the knife shaft,
wherein the circular knife is held and fixed on the knife shaft between an abutment of the knife shaft and a securing means, which is arranged on the side of the free end of the knife shaft, and
wherein at least one compensating element is arranged between the circular knife and the abutment and/or between the circular knife and the securing means.

2. The apparatus according to claim 1; further comprising two cutting units, which are configured identical in construction and are arranged spaced apart from each other substantially mirror-symmetrically on either side of a transport path for the product to be processed, in such a manner that the transport path for the product to be processed is formed between the two circular knives.

3. The apparatus according to claim 1, wherein the at least one compensating element is a flexible sealing element.

4. The apparatus according to claim 1, wherein the abutment for the circular knife is formed by a shoulder in the knife shaft.

5. The apparatus according to claim 1, wherein the circular knife and the at least one compensating element are held pressed against the abutment by of the securing means.

6. The apparatus according to claim 1 further comprising at least one sliding body, the at least one sliding body is arranged spaced apart radially from the knife shaft and configured to be be pressed against the circular knife.

7. The apparatus according to claim 6, wherein the at least one sliding body is positioned on an inner side of the circular knife directed towards the product to be processed.

8. The apparatus according to claim 7, wherein the at least one sliding body is arranged outside an engagement region of the circular knife in the product to be processed, the at least one sliding body configured to bear against the inner side of the circular knife directed towards the product to be processed.

9. The apparatus according to claim 6, wherein the at least one sliding body is configured to be actively controlled.

10. The apparatus according to claim 6, wherein at least two sliding bodies are provided, the at least two sliding bodies are configured to be controlled independently of each other.

11. The apparatus according to claim 6, wherein the at least one sliding body has at least one through-hole to which a connection element for coolant is configured to be connected.

12. The apparatus according to one claim 6, wherein the at least one sliding body is configured and adapted to be movable, in such a manner that a contact position of the at least one sliding body on the circular knife is variably adjustable.

13. The apparatus according to claim 1, wherein the circular knife has at least one aperture in addition to a recess for producing the form-fit with the knife shaft.

14. The apparatus according to claim 13, wherein the at least one aperture is a plurality of apertures which are configured as involutes or similar to an involute.

15. The apparatus according to claim 1, wherein a cutting edge of the circular knife has a first chamfer directed towards the meat to be detached and a second chamfer directed away from the meat, the first chamfer being longer than the second chamfer.

16. The apparatus according to claim 1 further comprising a control device.

17. An apparatus for automatically processing products of the food processing industry, the apparatus comprising:
a transport unit configured to transport the products to be processed in a transport direction T along a transport path through at least one processing station, the at least one processing station includes the apparatus according to claim 1, and
a control device for controlling the transport unit and the at least one processing station.

18. A method for automatically processing products of the food processing industry, the method comprising the steps of:
transporting the products to be processed along a transport path into a region of at least one processing station by a transport unit,
processing the products in the processing station,
detaching meat from a carcass by an apparatus for detaching meat from the carcass or parts thereof as the products to be processed, wherein
automatic execution is controlled by a control device, and
a circular knife of the apparatus for detaching the meat is passively controlled by the product to be processed, independently of the control device, during execution of the detaching step with respect to its position relative to the carcass by of mounting the circular knife on a knife shaft, which permits a compensating movement of the circular knife on the knife shaft.

19. The method according to claim 18, wherein the circular knife is passively controlled by at least one sliding body and is actively controlled, by the control device, when the meat is detached from the carcass, in that the at least one sliding body is actively pressed against the circular knife with adjustable pressure from an inner side of the circular knife directed towards the product to be processed.

20. The method according to claim 19, wherein at least two sliding bodies are provided, the at least two sliding bodies are configured to be actuated separately from one another in order to be brought into contact with the circular knife in different positions thereof.

21. The method according to claim 18, wherein a contact surface between the at least one sliding body and the circular knife is cooled at least during processing.

22. The method according to claim 18, wherein a position of the at least one sliding body is changed before and/or during processing to alter a position of a contact surface between the at least one sliding body and the circular knife radially to an axis of rotation of the knife shaft and/or about the axis of rotation of the knife shaft.

23. The method according to claim 18, wherein the method is executed by the apparatus according to claim 1.
